(19) United States
(12) Patent Application Publication
(10) Pub. No.: US 2008/0091660 A1
(43) Pub. Date: Apr. 17, 2008

(54) SYSTEM AND METHOD FOR SEARCHING INFORMATION USING SYNONYMS

(75) Inventors: Seung-Ick JANG, Daejon (KR); Tai-Woo CHANG, Daejon (KR); Yong-Jin KIM, Daejon (KR); Ho-Yon KIM, Daejon (KR); Jong-Heung PARK, Daejon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institue, Daejon (KR)

(21) Appl. No.: 11/872,028

(22) Filed: Oct. 14, 2007

(30) Foreign Application Priority Data
Oct. 16, 2006 (KR) 10-2006-0100500

(51) Int. Cl. G06F 7/00

(52) U.S. Cl. 707/3

(57) ABSTRACT

Provided are a system and method for searching information using synonyms. The system including: a synonym storing unit for storing synonyms; a similar Korean alphabet character elements storing unit for storing numbers and Korean alphabet character elements, or a combination of Korean alphabet character elements; a similar Korean alphabet character elements synonym creating unit for automatically creating a plurality of synonyms by combining synonym information and information on the numbers, and Korean alphabet character elements or the combination of Korean alphabet character elements, and providing the created synonyms to a querying unit; the querying unit for searching information stored in a database using synonyms stored in the synonym storing unit and a plurality of synonyms of the keyword automatically created by the similar Korean alphabet character elements synonym creating unit based on the inputted keyword.

### CROSS-REFERENCES TO RELATED APPLICATIONS

The present invention claims priority of Korean Patent Application Nos. 10-2006-0100500, filed on Oct. 16, 2006, which is incorporated herein by reference.

### BACKGROUND OF THE INVENTION

1. Field of the Invention

The present invention relates to a system and method for searching information using synonyms; and, more particularly, to an information searching system and method for creating synonyms based on character elements and letters having a similar pronunciation or morpheme, and searching information stored in a search object database using the created synonyms.

This work was supported by the Information Technology (IT) research and development program of the Korean Ministry of Information and Communication (MIC) and/or the Korean Institute for Information Technology Advancement (IITA) [2006-X004-01, “Development of Consolidation Technologies for Automatic Processing of Address Information”].

2. Description of Related Art

A synonym means a word having the same meaning and it includes assonant, homophone, heterography, and homography formed of character elements and letters having a similar or same pronunciation or morpheme. For example, in the present invention, ‘ETRI’ and [symbol] [symbol] 21 are called synonyms because they have the same meaning. ‘ETRI’ and [symbol] or [symbol] are called synonyms because they have a similar pronunciation. Thus, ‘ETRI ’, [symbol] [symbol] [symbol] and [symbol] are all synonyms.

Conventionally, information stored in a database is searched based on a query value inputted from a user, i.e., information searcher. Accordingly, when the information searcher inputs a wrong query value, i.e., a wrong keyword, there is a problem that a wrong result is acquired due to the absence of information corresponding to the keyword, or due to search of wrong information corresponding to the keyword.

To solve the above problem, a method for building information of synonyms and searching information stored in a database has been developed. However, the method requires a lot of intensive works and much time since a database manager should input and manage synonyms on all queries.

Also, when the information searcher searches information stored in the database using a borrowed word, the information searcher may obtain a wrong result in cases that the information stored in the database does not meet a borrowed word notation, that the borrowed word inputted by the information searcher is different from the information stored in the database, or that the information searcher inputs a wrong borrowed word. It is because the information corresponding to the inputted borrowed word does not exist or wrongly searched.

### SUMMARY OF THE INVENTION

An embodiment of the present invention is directed to providing an information searching system and method for creating synonyms based on character elements and letters having a similar pronunciation or morpheme, and searching information stored in a search object database using the created synonyms.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a system for searching information using synonyms, system including: a synonym storing unit for storing synonyms; a similar Korean alphabet character elements storing unit for storing numbers and Korean alphabet character elements, or a combination of Korean alphabet character elements, which have a similar pronunciation or morpheme, or which are confusing in recognizing a computer optical letter; a similar Korean alphabet character elements synonym creating unit for automatically creating a plurality of synonyms by combining synonym information stored in the synonym storing unit and information on the numbers, and Korean alphabet character elements or the combination of Korean alphabet character elements stored in the similar Korean alphabet character elements storing unit when a keyword is inputted, and providing the created synonyms to a querying unit; the querying unit for searching information stored in a database using synonyms stored in the synonym storing unit and a plurality of synonyms of the keyword automatically created by the similar Korean alphabet character elements synonym creating unit based on the inputted keyword.

In accordance with another aspect of the present invention, there is provided a method for searching information including a database, including the steps of: a) automatically creating a plurality of synonyms by combining synonym information stored in the synonym storing unit and information on the numbers, and Korean alphabet character elements or the combination of Korean alphabet character elements stored in the similar Korean alphabet character elements storing unit when a keyword is inputted, and providing the created synonyms to a querying unit; b) searching information stored in a database using synonyms stored in the synonym storing unit and a plurality of synonyms of the keyword automatically created by the similar Korean alphabet character elements synonym creating unit based on the inputted keyword.

### BRIEF DESCRIPTION OF THE DRAWINGS

FIG. 1 shows an information search system using synonyms in accordance with an embodiment of the present invention.

FIG. 2 is a flowchart describing an information search method using synonyms in accordance with an embodiment of the present invention.

FIG. 3 shows information stored in a synonym database, a similar Korean alphabet character elements database, a similar English alphabet/number database and a search object database in accordance with an embodiment of the present invention.

FIG. 4 shows an information search method using synonyms of the database querying unit in accordance with an embodiment of the present invention.

FIG. 5 shows an information search method using synonyms of the database querying unit in accordance with another embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

The present invention based on a Korean alphabet, an English alphabet/number will be described in detail with an example hereinafter. However, the present invention is not limited to the Korean alphabet, and the English alphabet/number.

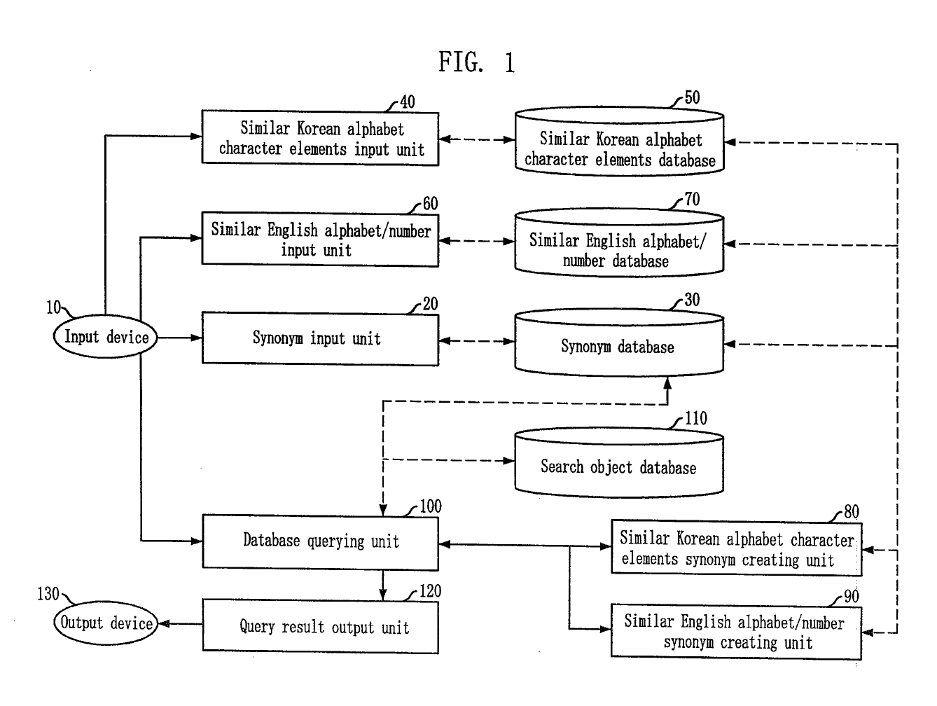

FIG. 1 shows an information search system using synonyms in accordance with an embodiment of the present invention.

Referring to FIG. 1, the information search system using synonyms according to the present invention includes an input device 10, a synonym input unit 20, a synonym database 30, a similar Korean alphabet character elements input unit 40, a similar Korean alphabet character elements database 50, a similar English alphabet/number input unit 60, a similar English alphabet/number database 70, a similar Korean alphabet character elements synonym creating unit 80, a similar English alphabet/number synonym creating unit 90, a database querying unit 100, a search object database 110 and a query result output unit 120.

A function of constituent elements of the information search system using synonyms will be described in detail hereinafter.

The input device 10 includes a keyboard, a mouse, and a touchpad that a database manager and a user, i.e., an information searcher, can input character elements and letters.

The synonym input unit 20 receives synonyms on information stored in the search object database 110 from the database manager through the input device 10. The synonym database 30 stores the synonyms inputted through the synonym input unit 20.

The similar Korean alphabet character elements input unit 40 receives Korean alphabet character elements or a combination of Korean alphabet character elements such as a Korean alphabet syllable and a word, which are similar to the information stored in the search object database 110 in a pronunciation or a format, or which are confusing in recognizing a computer optical letter, from the database manager through the input device 10. The similar Korean alphabet character elements database 50 stores the Korean alphabet character elements inputted through the similar Korean alphabet character elements input unit 40 or a combination of the character elements such as a Korean alphabet syllable and a word.

The similar English alphabet/number input unit 60 receives an English alphabet/number or a combination of English alphabet/number, which are similar to the information stored in the search object database 110 in a pronunciation or a format, or which are confusing in recognizing a computer optical letter, from the database manager through the input device 10. The similar English alphabet/number database 70 stores the English alphabet/number or the combination of the English alphabet/number through the similar English alphabet/number input unit 60.

When the similar Korean alphabet character elements synonym creating unit 80 receives a request for synonyms from the database querying unit 100, the similar Korean alphabet character elements synonym creating unit 80 automatically creates a plurality of synonyms by combining information on the synonyms stored in the synonym database 30, and information on a combination of Korean alphabet character elements or Korean alphabet character elements stored in the similar Korean alphabet character elements database 50, e.g., a Korean alphabet syllable and word, and provides the created synonyms to the database querying unit 100.

When the database querying unit 100 requests synonyms, the similar English alphabet/number synonym creating unit 90 automatically creates a plurality of synonyms by combining information on the synonyms stored in the synonym database 30, information on a combination of Korean alphabet character elements or Korean alphabet character elements stored in the similar Korean alphabet character elements database 50, e.g., a Korean alphabet syllable and word, and information on the English alphabet/number and the combination of the English alphabets/numbers stored in the similar English alphabet/number database 70, and provides the created synonyms to the database querying unit 100.

The database querying unit 100 receives a keyword from the information searcher through the input device 10, searches information stored in the search object database 110, which stores the information desired by the information searcher, using the synonyms pre-stored in the synonym database 30 and a plurality of synonyms of the keyword automatically created by the similar Korean alphabet character elements synonym creating unit 80 and the similar English alphabet/number synonym creating unit 90, and provides the searched result to the query result output unit 120.

The query result output unit 70 provides information corresponding to the keyword inputted through the database querying unit 100 to the information searcher through an output device 130. The output device 130 denotes a device for providing information to the information searcher as a sense of sight or a sense of hearing through the user interface.

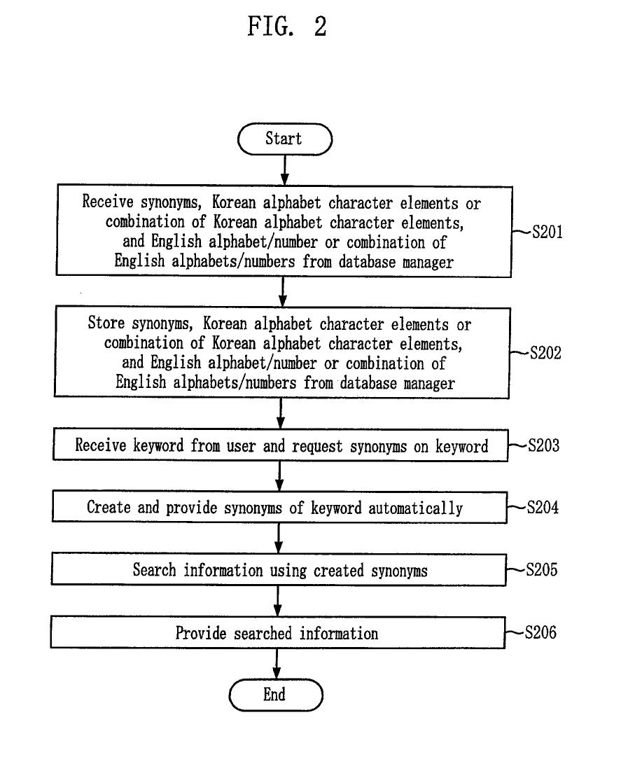

FIG. 2 is a flowchart describing an information search method using synonyms in accordance with an embodiment of the present invention.

At step S201, the synonym input unit 20, the similar Korean alphabet character elements input unit 40 and the similar English alphabet/number input unit 60 receives synonyms on the information stored in the search object database 110 from the database manager through the input device 10, the Korean alphabet character elements or the combination of the Korean alphabet character elements, which are similar to the information stored in the search object database 110 in a pronunciation or a format, or which are confusing in recognizing a computer optical letter, such as the Korean alphabet syllable or word, and the English alphabet/number or the combination of the English alphabets and numbers, which are similar to the information stored in the search object database 110 in a pronunciation or a format, or which are confusing in recognizing a computer optical letter, from the database manager through the input device 10.

At step S202, the synonym database 30, the similar Korean alphabet character elements database 50 and the similar English alphabet/number database 70 stores synonyms inputted through the synonym input unit 20, the similar Korean alphabet character elements input unit 40 and the similar English alphabet/number input-unit 60, the Korean alphabet character elements and the combination of the Korean alphabet character elements such as the Korean alphabet syllable or word, and the English alphabet/number or the combination of English alphabets/numbers.

At step S203, the database querying unit 100 receives a keyword from the information searcher through the input device 10 and requests synonyms on the keyword to the similar Korean alphabet character elements synonym creating unit 80 and the similar English alphabet/number synonym creating unit 90.

At step S204, the similar Korean alphabet character elements synonym creating unit 80 and the similar English alphabet/number synonym creating unit 90 combines information stored in the similar Korean alphabet character elements database 50 and the similar English alphabet/number database 70 upon request of the database querying unit 100, automatically creates synonyms of the keyword, and provides the created synonyms to the database querying unit 100.

At step S205, the database querying unit 100 searches information stored in the search object database 110 using synonyms of the keyword transmitted from the similar Korean alphabet character elements synonym creating unit 80 and the similar English alphabet/number synonym creating unit 90 and synonyms pre-stored in the synonym database 30, and provides a searched result to the query result output unit 120.

At step S206, the query result output unit 120 provides the searched information, which is transmitted from the database querying unit 100, to the information searcher through the output device 130.

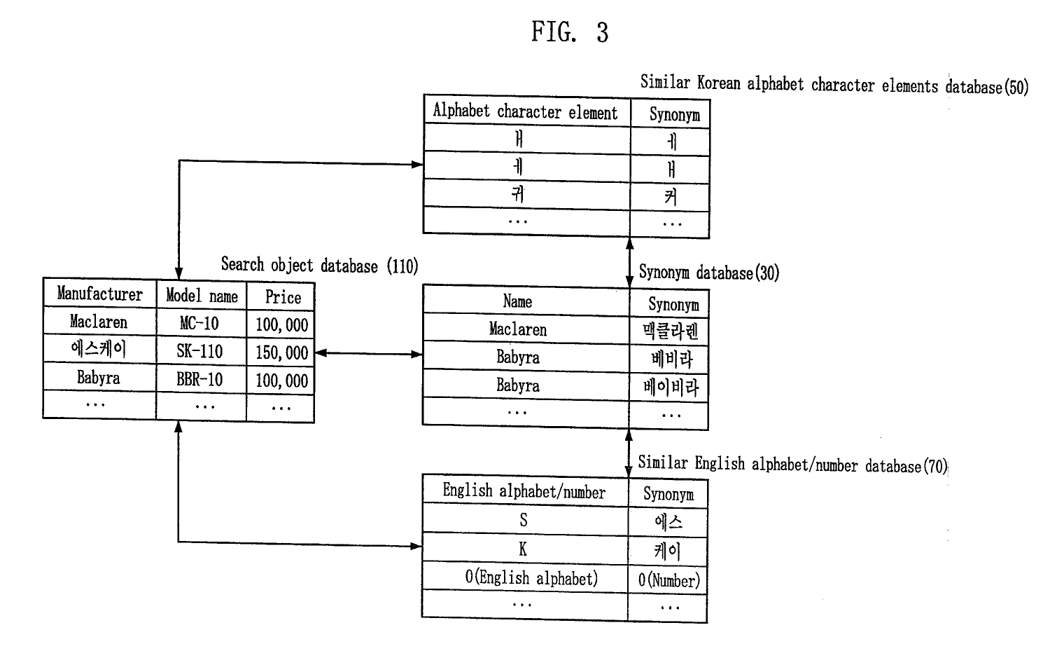

FIG. 3 shows information stored in a synonym database, a similar Korean alphabet character elements database, a similar English alphabet/number database and a search object database in accordance with an embodiment of the present invention.

Referring to FIG. 3, the similar Korean alphabet character elements database 50 stores Korean alphabet character elements inputted through the similar Korean alphabet character elements input unit 40, e.g., a vowel [symbol] and character elements having a similar pronunciation, e.g., a vowel [symbol] as a synonym. Also, the similar Korean alphabet character elements database 50 stores a combination of Korean alphabet character elements, e.g., a Korean alphabet syllable [symbol] and a combination of Korean alphabet character elements, which are confusing due to a similar format, e.g., a alphabet syllable [symbol] as synonyms.

The synonym database 30 stores a combination of English alphabets inputted through the synonym input unit 20, e.g., ‘Maclaren’, and a combination of Korean alphabet character elements, which are formed of a similar pronunciation, e.g., [symbol] The synonym database 30 stores a combination of English alphabets, e.g., ‘Babyra’ and combinations of Korean alphabet character elements, which are formed of a similar pronunciation, e.g., [symbol] and [symbol] as a synonym.

The similar English alphabet/number database 70 stores an English alphabet/number inputted through the similar English alphabet/number input unit 60, e.g., an English alphabet ‘S’, and a combination of Korean alphabet character elements, which are formed of a similar pronunciation, e.g., [symbol] as a synonym. The similar English alphabet/number database 70 stores an English alphabet/number, e.g., an English alphabet ‘K’, and a combination of Korean alphabet character elements, which are formed of a similar pronunciation, e.g., [symbol] as a synonym. The similar English alphabet/number database 70 stores an English alphabet/number, e.g., an English alphabet ‘O’, and an English alphabet/number, which are confusing due to the same format, e.g., a number ‘0’, as synonyms.

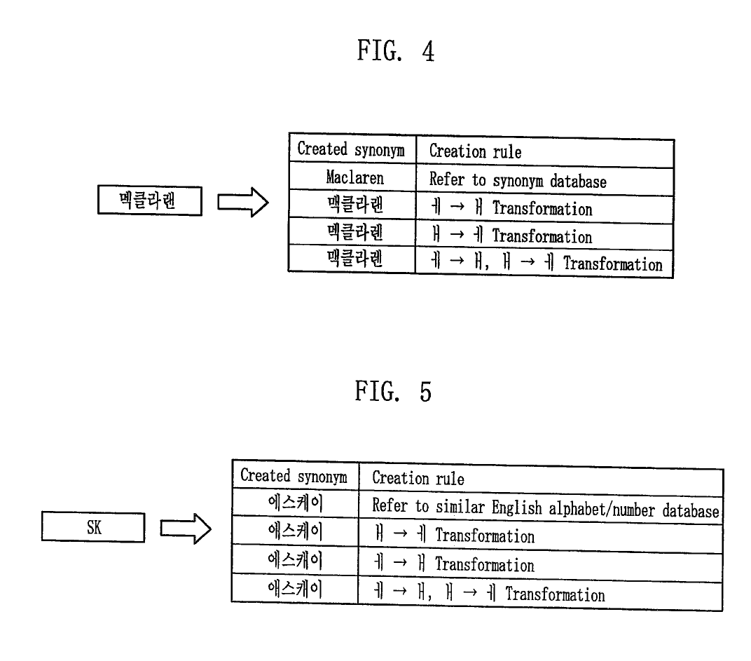

FIG. 4 shows an information search method using synonyms of the database querying unit in accordance with an embodiment of the present invention.

Referring to FIG. 4, the database querying unit 100 according to the present invention requests a synonym of a keyword [symbol] inputted through the input device 10 to the similar Korean alphabet character elements synonym creating unit 80, and searches information ‘Maclaren’ stored in the search object database 110 (see FIG. 3) using a plurality of synonyms [symbol] [symbol] and [symbol] of a keyword [symbol] provided from the similar Korean alphabet character elements synonym creating unit 80, and a synonym ‘Maclaren’ of a keyword [symbol] pre-stored in the synonym database 30.

The database querying unit 100 requests a keyword as a synonym, the similar Korean alphabet character elements synonym creating unit 80 creates a plurality of synonyms [symbol] [symbol] and [symbol] of a keyword [symbol] based on information that Korean alphabet character elements stored in the similar Korean alphabet character elements database 50 are synonyms, e.g., vowels [symbol] and [symbol] , and provides the created synonyms to the database querying unit 100 (see FIG. 3).

FIG. 5 shows an information search method using synonyms of the database querying unit in accordance with another embodiment of the present invention.

Referring to FIG. 5, the database querying unit 100 according to the present invention requests synonyms of a keyword ‘SK’ inputted through the input device 10 to the similar English alphabet/number synonym creating unit 90, and searches information [symbol] stored in the search object database 110 using a plurality of synonyms [symbol] [symbol] and [symbol] of the keyword ‘SK’ provided from the similar English alphabet/number synonym creating unit 90.

When the database querying unit 100 requests synonyms of the keyword ‘SK’, the similar English alphabet/number synonym creating unit 90 creates a synonym [symbol] based on information on a synonym [symbol] of an English alphabet ‘S’ and a synonym [symbol] of an English alphabet ‘K’ among keywords stored in the similar English alphabet/number database 70, creates a plurality of synonyms [symbol] [symbol] and [symbol] based on information that Korean alphabet character elements stored in the similar Korean alphabet character elements database 50, e.g., vowels [symbol] and [symbol] are synonyms, and provides the created synonyms to the database querying unit 100 (see FIG. 3).

The present invention described above can search information stored in a database within a wide range by creating synonyms based on character elements and letters having a similar pronunciation or morpheme, and searching information stored in a search object database based on the created synonyms.

Since the present invention automatically creates synonyms, the database manager does not need to manually input all synonyms and the information searcher can acquire desired information although the information searcher inputs a keyword of a format different from the information stored in the actual search object database.

Also, the present invention can maximize efficiency of search in diverse fields such as diverse optical letters recognition-based applications by creating synonyms based on character elements or English alphabets/numbers of a similar format, which are confusing in recognizing a computer optical letter.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

While the present invention has been described with respect to the specific embodiments, it will be apparent to those skilled in the art that various changes and modifications may be made without departing from the spirit and scope of the invention as defined in the following claims.

What is claimed is:

1. A system for searching information using synonyms, comprising:
a synonym storing means for storing synonyms;
a similar Korean alphabet character elements storing means for storing numbers and Korean alphabet character elements, or a combination of Korean alphabet character elements, which have a similar pronunciation or morpheme, or which are confusing in recognizing a computer optical letter;
a similar Korean alphabet character elements synonym creating means for automatically creating a plurality of synonyms by combining synonym information stored in the synonym storing means and information on the numbers, and Korean alphabet character elements or the combination of Korean alphabet character elements stored in the similar Korean alphabet character elements storing means when a keyword is inputted, and providing the created synonyms to a querying means; and
the querying means for searching information stored in a database using synonyms stored in the synonym storing means and a plurality of synonyms of the keyword automatically created by the similar Korean alphabet character elements synonym creating means based on the inputted keyword.

2. The system of claim 1, further comprising:
a similar English alphabet/number character elements storing means for storing numbers and English alphabets, or a combination of English alphabets, which have a similar pronunciation or morpheme, or which are confusing in recognizing a computer optical letter; and
a similar English alphabet/number synonym creating means for automatically creating a plurality of synonyms by combining synonym information stored in the synonym storing means and information on the numbers, Korean alphabet character elements or the combination of Korean alphabet character elements stored in the similar Korean alphabet character elements storing means, and information on English alphabets/numbers and a combination of English alphabets/numbers stored in the similar English alphabet/number character elements storing means when a keyword is inputted, and providing the created synonyms to a querying means.

3. The system of claim 1, wherein the synonym means a word having the same meaning, and includes assonant, homophone, heterography, and homography, which are formed of character elements and letters having a similar or same pronunciation or morpheme, and numbers, character elements and combination of character elements, which are confusing in recognizing a computer optical letter.

4. A method for searching information including a database, comprising the steps of:
a) automatically creating a plurality of synonyms by combining synonym information stored in a synonym storing means and information on the numbers, and Korean alphabet character elements or the combination of Korean alphabet character elements stored in the similar Korean alphabet character elements storing means when a keyword is inputted, and providing the created synonyms to a querying means; and
b) searching information stored in a database using synonyms stored in the synonym storing means and a plurality of synonyms of the keyword automatically created by a similar Korean alphabet character elements synonym creating means based on the inputted keyword.

5. The method of claim 4, further comprising the steps of:
c) automatically creating a plurality of synonyms by combining synonym information stored in the synonym storing means and information on the numbers, Korean alphabet character elements or the combination of Korean alphabet character elements stored in the similar Korean alphabet character elements storing means, and information on English alphabets/numbers and a combination of English alphabets/numbers stored in the similar English alphabet/number character elements storing means when a keyword is inputted; and
d) searching information stored in a database using synonyms stored in the synonym storing means of the step b), a plurality of synonyms of a keyword automatically created by the similar Korean alphabet character elements synonym creating means, and synonyms created in the step c).

6. The method of claim 4, wherein a synonym means a word having the same meaning, and includes assonant, homophone, heterography, and homography, which are formed of character elements and letters having a similar or same pronunciation or morpheme, and numbers, character elements and combination of character elements, which are confusing in recognizing a computer optical letter.
